(19) United States
(12) Patent Application Publication
(10) Pub. No.: US 2003/0174218 A1
(43) Pub. Date: Sep. 18, 2003

(54) System for capturing audio segments in a digital camera

(76) Inventors: Amy E. Battles, Windsor, CO (US); David J. Staudacher, Fort Collins, CO (US); Miles Thorland, Fort Collins, CO (US); David M. Frohlich, Trim Bristol (GB)

Correspondence Address: HEWLETT-PACKARD COMPANY, Intellectual Property Administration, P.O. Box 272400, Fort Collins, CO, 80527-2400, US

(21) Appl. No.: 10/098,135

(22) Filed: Mar. 14, 2002

(51) Int. Cl. H04N 5/225

(52) U.S. Cl. 348/231.4

(57) ABSTRACT

A system for capturing, via a digital camera, an audio clip either before, during, or after the capture of an associated photographic image. The system allows a user to associate an audio clip with a corresponding photographic image by using two shutter button positions to respectively control the initiation of an audio recording and the termination thereof. In operation, a user presses shutter button to a partially depressed position which initiates audio capture. The user then fully depresses the shutter button, which initiates image capture with continued recording of the audio clip. Audio recording continues until the shutter button is filly released. The recorded audio clip and corresponding image are stored in local camera memory in a format that allows them to be re-associated when the memory is downloaded from the camera.

### FIELD OF THE INVENTION

The present invention relates generally to digital cameras, and more particularly, to a system for capturing segments of audio information together with photographic images in a digital camera in accordance with user-selectable options.

Statement of the Problem

Previously existing digital cameras allow a user to record an audio segment, or ‘clip’ and associate it with a captured photographic image (a ‘picture’). However, previous methods have one or more of the following limitations:

(a) after taking a picture, the user must press another button before the audio clip can be recorded;

(b) the camera must be set up in advance to automatically record audio for a specified length of time, after the picture is taken; and/or

(c) the camera may record audio for a variable length of time after the picture is taken, while the shutter button remains pressed down.

In all of the above cases, the user is precluded from recording the audio prior to taking the picture, or simultaneously capturing the audio along with the photograph. This makes it difficult to record audio in situations wherein an audio event precedes, or occurs simultaneously with, a corresponding event to be photographed.

With respect to case (a), recording the audio clip requires that the user take a specific action after taking the picture; i.e., another button must be pressed after pressing the shutter button. This limitation makes recording the audio clip more of an afterthought, and requires conscious effort on the part of the user. In case (b), the user must decide, in advance of recording the audio clip, the exact duration of the clip.

Therefore, what is needed is a method that does not limit the recording of an audio clip until a period subsequent to the capture of a corresponding image.

Solution to the Problem

The present system provides a mechanism for capturing an audio clip either before, during, or after the capture of an associated photographic image. A digital camera constructed in accordance with the present system allows a user to associate an audio clip with a corresponding photographic image by using two shutter button positions to respectively control the initiation of an audio recording and the termination thereof.

In operation, a user presses the shutter button to a partially depressed position, which initiates audio capture (recording), as well as other functions such as auto-focus and auto-exposure. The user then fully depresses the shutter button, which initiates image capture and recording of the audio clip. Audio recording continues until the shutter button is fully released. The recorded audio clip and corresponding image are stored in local camera memory in a format that allows them to be re-associated when the memory is downloaded from the camera.

An optional feature of the present system includes a user-selectable, preset minimum recording time, so that if the shutter button remains depressed to a fully depressed position for a duration less than the preset minimum, the audio clip is nevertheless recorded for a minimum length of time. If the user presses the shutter button to a partially depressed position and releases the button without depressing it all the way to the fully depressed position, the audio clip is discarded, or saved with no attached image.

The present system thus provides the ability to capture exactly the desired image and audio clip, as the user has real-time control over the interval of initiation and termination of the audio recording, as well as the point within that interval at which the associated image is captured. In addition, in contrast to the prior art, the user may initiate recording of the audio clip prior to, or during the image capture process.

### BRIEF DESCRIPTION OF THE DRAWINGS

FIG. 1 is a diagram showing an exemplary embodiment of a digital camera used in the present system;

FIG. 2 is a flowchart illustrating exemplary basic steps employed in carrying out one embodiment of the present system;

FIG. 3 is a diagram illustrating the storage of audio and associated images in camera memory; and

FIG. 4 is a flowchart illustrating exemplary steps employed in carrying out an alternative embodiment of the present system.

### DETAILED DESCRIPTION

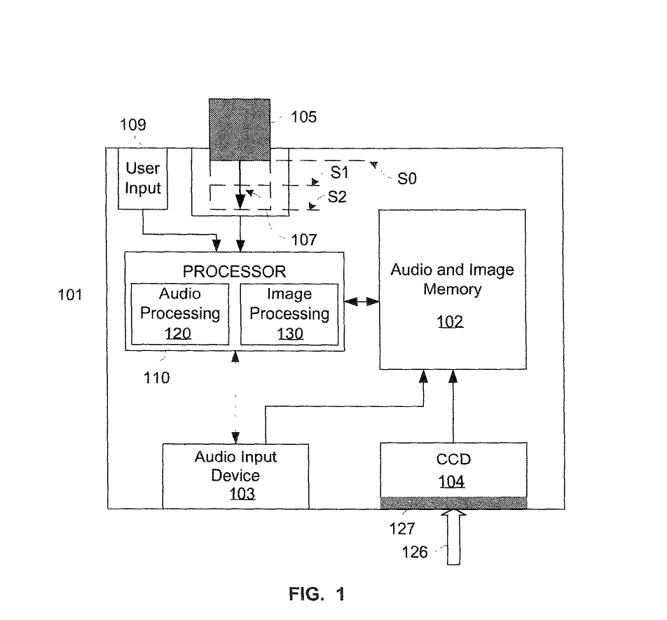

FIG. 1 is a diagram showing an exemplary embodiment of a digital camera used in the present system. As shown in FIG. 1, camera 101 comprises a light receiving device 104, such as a CCD or CMOS imager, a microphone or other audio input device 103 for receiving ambient audio, a processor 110, and a memory module 102, for storing audio and image data. In an exemplary embodiment, light receiving device 104 is a CCD imager that detects light 126, input through camera lens 127, from the subject to be photographed. In an exemplary embodiment of the present system, processor 110 is programmable and includes an image processing module 130, and a module 120 for processing the audio functions performed by the present system, including the recording and storing of audio segments, as described herein. The functions performed by audio processing module 120 and image processing module 130 may be executed in firmware or hardware, and the modules 120/130 may be external to processor 120. Modules 120/130 may, alternatively, be combined into a single module. Memory module 102 may, alternatively, be divided into different memory types, such as temporary (e.g., RAM) and permanent memory (e.g., flash memory).

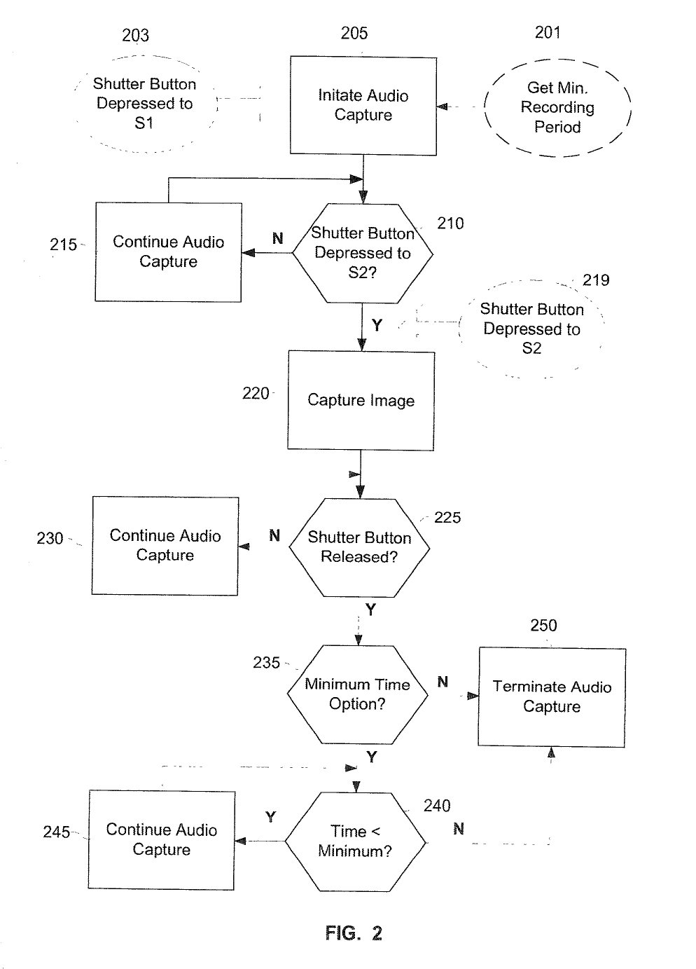

Camera 101 further comprises a user input device 109 coupled to processor 110, and a shutter button (or switch) 105 for initiating the capture (exposure) of an image, and for controlling the capture of a segment of audio information, hereinafter also referred to as an audio ‘clip’. User input device 109 is employed for entering user-selectable options, and may be any suitable mechanism, such as a displayable menu with an associated menu item selector. When shutter button 105 is depressed, it first moves, in the direction indicated by arrow 107, from initial position S0 to partially depressed position S1, which initiates the capture of an audio clip. The button 105 may then be further depressed to position S2, at which point an image is captured, i.e., a picture is taken, and audio capture is stopped when shutter button 105 is released. Shutter button 105 is coupled to processor 110 so that the processor detects its location relative to positions S1 and S2. The relationship between shutter button positions and the capture of images and associated audio clips is explained in detail below with respect to FIG. 2.

FIG. 2 is a flowchart illustrating exemplary basic steps employed in one embodiment of the present system for capturing audio clips and associating them with corresponding images. As shown in FIG. 2, at step 201, a user optionally enters a value representing the minimum recording duration for an audio clip, via user input device 109. If no minimum duration is entered, camera 101 captures audio segments for only the length of time that shutter button 105 is depressed to the S1 position or further, as explained below.

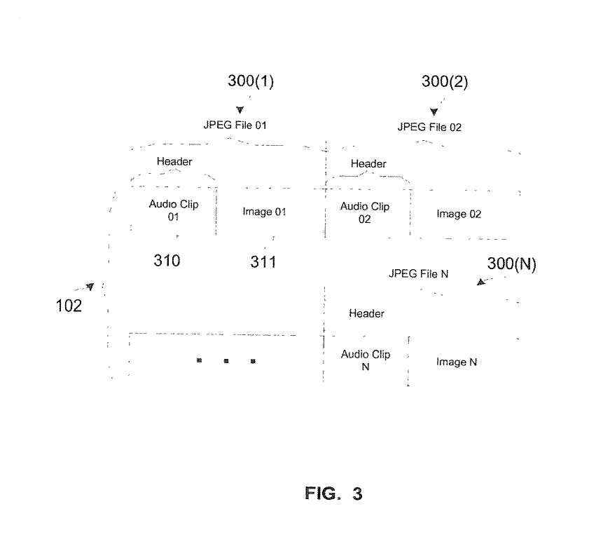

At step 203, the user partially depresses shutter button 105, so that it reaches position S1. Shutter button 105 preferably provides tactile feedback so that the user can determine when position S1 is encountered. When processor 110 detects that shutter button 105 has been depressed to the S1 position, at step 205, capture of audio information (i.e., an audio clip) via audio input device 103 is initiated. Other camera functions such as auto-focus and auto-exposure may also be initiated at this point. Audio processing module 120 includes an A/D converter which converts the received audio information, which is in analog form, to digital data. The digitized audio data is stored in memory 102, as explained in detail with respect to FIG. 3. At steps 210 and 215, audio capture continues as long as the shutter button is pressed at least to the S1 position. If, however, the user presses the shutter button to the S1 position and releases the button without depressing it all the way to the S2 position, the audio clip is discarded. Alternatively, the audio clip could be saved without an accompanying image.

At step 219, the user fully depresses shutter button 105, so that it reaches position S2, which causes an image to be captured, via CCD imager 104, and stored in memory 102 at step 220. The image capture and storage functions are controlled by image processing module 130, which also typically performs image compression into a format such as JPEG. It should be noted that images may also be saved in an uncompressed format, such as a TIFF format, for example, and that compressed images may be stored in compression formats other than JPEG. At steps 225 and 230, audio capture continues until shutter button 105 is released back past the S1 position, i.e., until the button is in the position between S1 and S0. At step 235, if the user has not set a minimum audio clip duration in step 201, then the capture of audio information is terminated, at step 250. If, however, the user has set a minimum duration for the audio clip, audio capture continues at steps 240 and 245 until the amount of time, set in step 201, has elapsed subsequent to the shutter button having reached position S1. The capture of audio information is then terminated, at step 250.

FIG. 3 is a diagram illustrating the storage of audio and associated images in camera memory in an exemplary embodiment of the present system. As shown in FIG. 3, memory 102 contains a plurality of (N) JPEG files 300(1)-300(N), each containing an audio clip 310 and corresponding image 311. After an image is captured by camera 101, it is compressed (using a firmware or hardware component that is well-known in the art) into a JPEG format and stored in memory 102. When audio capture is terminated (at step 250 in FIG. 2), an audio ‘clip’ is created in memory 102, under the control of audio processing module 120, in accordance with the format shown in FIG. 3. When an audio clip is created, it is moved from an area in memory, where it was originally stored, to the header of a JPEG file containing the image with which the clip is associated. Alternatively, each audio clip and corresponding image may be initially stored, when captured, in adjacent areas which are subsequently formatted as a single JPEG file in accordance with a desired JPEG format.

There are presently a number of different JPEG specifications, several of which have provisions for storing image-supplementary information as a segment which is part of a JPEG file. Regardless of the fact that certain JPEG specifications do not formally define a ‘header’ area as such, the present system may use any available segment of any type of JPEG file, such as a user-defined header area or equivalent, for storing audio information corresponding to the image data stored in the same file. Although, in the presently described embodiment, image data is stored in a JPEG format with associated audio information stored in a JPEG header, it is to be noted that any data format, such as TIFF or bitmap, may be used for storage of captured images. Furthermore, the audio information (clip) corresponding to a given image may, alternatively, be stored anywhere in memory 102, using any one of a number of schemes for establishing a correspondence between two data items, such as address pointers, or file name similarities as is well-known in the art. In the present embodiment, the audio and image information is stored in 2 separate files. Images and corresponding audio clips stored non-contiguously in memory 102 may be retrieved by audio processing module 120 in a contiguous fashion so that they are suitably co-associated with a JPEG or other file type, when downloaded from the camera 101.

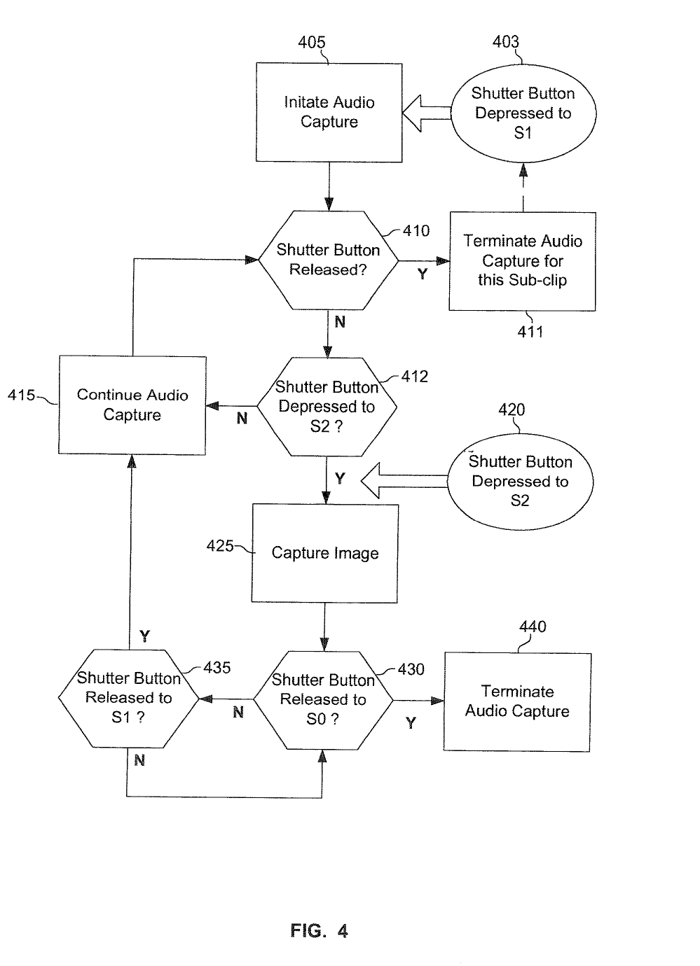

FIG. 4 is a flowchart illustrating exemplary steps employed in carrying out an alternative embodiment of the present system. As shown in FIG. 4, at step 403, the user partially depresses shutter button 105 to position S1. When processor 110 detects that shutter button 105 has been depressed to the S1 position, at step 405, capture of audio information via audio input device 103 is initiated. The captured audio is stored in memory 102, as explained above with respect to FIG. 3. At step 410, if the shutter button is released to the SO position before being depressed to position S2, then audio capture is terminated, and an audio sub-clip is created, at step 411. When the shutter button is again depressed to position S1 (at step 403), capture of an additional audio sub-clip is initiated (at step 405). In this manner, several time-wise discontiguous segments of audio may be captured by repetitively pressing the shutter button to position S1 and releasing it to position S0 before depressing the button to S2 to capture an image that is associated with each of the audio sub-clips. The audio data for each of the sub-clips may be stored sequentially in the header corresponding to the associated image. Alternately, the audio data for each of the sub-clips may be stored as individual audio files with no image attached. Alternatively, the audio data and the image data may be stored in separate files having file name similarities, e.g., having the same file name with different extensions. For example, the audio data may be stored in a ‘.WAV’ file (or any other suitable format), designated (in this particular case) “IM00043.WAV”, and the image data stored in a JPEG file designated “IM00043.JPG”. The camera 101 and/or software in a user's PC then matches the audio and image files using the common file name “IM00043”. Implementation of the audio/image storage aspect of the present system requires only that there be a method, either internal to camera 101 or external thereto, for associating a particular audio clip with a corresponding image in memory 102, assuming that such an image has been captured.

At steps 412 and 415, audio capture continues as long as the shutter button is pressed at least to the S1 position. At step 420, the user fully depresses shutter button 105, so that it reaches position S2, which causes an image to be captured and stored in memory 102 at step 425. At step 430, if the shutter button is fully released to position SO, then audio capture is terminated, at step 440. If, however, the shutter button is partially released to position S1, then audio capture continues (at step 415), and additional images may be captured by depressing the shutter button back and forth between positions S2 and S1, as indicated in steps 425-435. Audio capture continues until shutter button 105 is released back to the S0 position, which terminates audio capture (step 440) for the sequence of corresponding images. In this manner, a continuous audio segment may be captured and associated with multiple images by taking a picture, then releasing up only to S1, then pressing S2 to take another picture.

In order to provide the proper association in memory 102 between multiple images and a single audio clip, the audio data may be broken up into segments, each of which is stored with a different image. The audio could be played back continuously in a slide show, for example. Alternatively, a single audio clip may be inserted in the header for the first image of a series, with the remaining images having blank (empty) audio headers. As a further alternative, the audio data for the clip may be replicated by audio processing module 120 and stored in the header for each of the associated images.

While exemplary embodiments of the present invention have been shown in the drawings and described above, it will be apparent to one skilled in the art that various embodiments of the present invention are possible. For example, the functional blocks shown in FIG. 1, the specific sequence of steps described in FIGS. 2 and 4, and the formatting shown in FIG. 3 should not be construed as limiting the invention herein described. Modification may be made to these and other specific elements of the invention without departing from its spirit and scope as expressed in the following claims.

We claim:

1. A digital camera comprising:
an audio input device for receiving ambient audio information;
a memory module;
a shutter button having a released position, a partially depressed position, and a fully depressed position; and
a processor coupled to the audio input device, the shutter button, and the memory module;
wherein:
capture of an audio segment comprising the ambient audio information is initiated by the processor when the shutter button is depressed to the partially depressed position;
capture of an image is initiated by the processor when the shutter button is depressed to the fully depressed position; and
capture of the audio segment is terminated by the processor when the shutter button is released to the released position.

2. The digital camera of claim 1, wherein the processor includes an audio processing module, and wherein the audio processing module initiates and terminates the capture of the audio segment irrespective of when said image is captured.

3. The digital camera of claim 2, wherein the audio segment and a corresponding said image are co-associated in the memory module by the processor.

4. The digital camera of claim 1, further comprising a light receiving device coupled to the processor; wherein said image is captured by the light receiving device when the shutter button is depressed to the fully depressed position.

5. The digital camera of claim 1, further comprising a user input device, coupled to the processor, for receiving input indicative of a minimum duration of said audio segment; wherein said capture of the audio segment continues until the segment has been captured for a length of time at least equal to said minimum duration.

6. The digital camera of claim 1, wherein more than one said audio segment is captured and associated with a single said image when the shutter button is repetitively depressed between the released position and the partially depressed position, prior to the shutter button being depressed to the fully depressed position.

7. The digital camera of claim 1, wherein more than one said image is captured and associated with at least one said audio segment when the shutter button is repetitively depressed between the partially depressed position and the fully depressed position, prior to the shutter button being released.

8. The digital camera of claim 7, wherein continuous capture of the audio segment occurs while each said image is captured.

9. The digital camera of claim 1, further comprising an audio processing module that converts said image into a compressed image and stores the compressed image in a file, and stores said audio segment in a segment of the file.

10. The digital camera of claim 9, wherein the compressed image is in a JPEG format, and the audio segment is stored in a header associated with the file.

11. The digital camera of claim 9, wherein said audio segment is stored in a second file, separate from the file wherein the image is stored.

12. A system for capturing, by a digital camera having a shutter button, an audio segment comprising ambient audio information, wherein at least part of the audio segment is captured prior to the capture of an associated photographic image by the camera, the system comprising the steps of:
capturing the audio segment when the shutter button is depressed to a partially depressed position;
capturing the image when the shutter button is depressed to a fully depressed position: and
terminating capture of the audio segment when the shutter button is released.

13. The system of claim 12, including the additional step of associating the audio segment and a corresponding image in a memory module in the camera.

14. The system of claim 12, including the additional step of receiving input indicative of a minimum duration of said audio segment; wherein said capturing of the audio segment continues until the segment has been captured for a length of time at least equal to said minimum duration.

15. The system of claim 12, including the additional step of capturing more than one said audio segment when the shutter button is repetitively released and partially depressed, prior to the shutter button being depressed to the fully depressed position.

16. The system of claim 15, including the additional step of associating said audio segment with a single said image in a memory module in the camera.

17. The system of claim 12, including the additional step of capturing more than one said image when the shutter button is repetitively depressed between the partially depressed position and the fully depressed position prior to the shutter button being released.

18. The system of claim 17, including the additional step of associating each said image with at least one said audio segment in a memory module in the camera.

19. The system of claim 17, wherein continuous capture of the audio segment occurs while each said image is captured.

20. The system of claim 12, including the additional steps of: converting said image into a compressed image;
storing the compressed image in a file: and
storing said audio segment in a segment of the file.

21. A digital camera comprising:
an audio input device for receiving ambient audio information:
a light receiving device for receiving light from a subject;
a shutter button having a released position, a partially depressed position, and a fully depressed position;
an image processing module;
an audio processing module, coupled to the audio input device and the shutter button; and
a memory module, coupled to the light receiving device, the audio input device, the image processing module, and the audio processing module;
wherein:
capture of an audio segment comprising the ambient audio information is initiated by the audio processing module when the shutter button is depressed to the partially depressed position;
capture of an image is initiated by the image processing module when the shutter button is depressed to the fully depressed position;
capture of the audio segment is terminated by the audio processing module when the shutter button is released to the released position: and
wherein the audio segment and a corresponding said image are co-associated in the memory module.

22. The digital camera of claim 21, further comprising an audio processing module that converts said image into a compressed image and stores the compressed image in a file, and stores said audio segment in a segment of the file.

23. The digital camera of claim 22 wherein the compressed image is in a JPEG format, and the audio segment is stored in a header associated with the file.

24. The digital camera of claim 22, wherein said audio segment is stored in a second file, separate from the file wherein the image is stored.
